(19) United States
(12) Patent Application Publication
(10) Pub. No.: US 2005/0204398 A1
(43) Pub. Date: Sep. 15, 2005

(54) Method for download of DVD metadata for DVD recorders

(75) Inventor: Kim Annon Ryal, Poway, CA (US)

Correspondence Address: CARPENTER & KULAS, LLP, 1900 EMBARCADERO ROAD, SUITE 109, PALO ALTO, CA, 94303, US

(73) Assignees: Sony Corporation, Tokyo (JP); Sony Electronics Inc., Park Ridge, NJ (US)

(21) Appl. No.: 10/797,856

(22) Filed: Mar. 9, 2004

(51) Int. Cl. H04N 7/173; H04N 7/10; H04N 7/025; G06F 17/24; G06F 17/21

(52) U.S. Cl. 725/112; 725/135; 725/113; 715/500.1; 715/501.1; 725/25

(57) ABSTRACT

In accordance with an embodiment of the present invention, a system and method are described for enhancing the viewing of a broadcast movie with independently acquired metadata. The metadata is linked with the movie by a hash signature that is generated from at least one scene change in the movie. The broadcast movie and features provided by the metadata are automatically recorded to a DVD for subsequent viewing.

### BACKGROUND OF THE INVENTION

The present invention generally relates to video entertainment and, more specifically, to a method for combining metadata with a broadcast movie.

For many years, movie studios have been distributing digital versatile disks, commonly referred to as DVDs, of popular movies for purchase or rental. These commercially produced DVDs provide the movie as well as other features such as a version of the movie known as the director's cut, interviews with the director and actors, as well as additional out-takes footage, audio tracks and camera angles. Some of these DVDs may also include a video game related to the movie. Commercially produced DVDs are very popular among viewers and have become an important source of income for the movie studios and other businesses in the video rental and distribution business. Unfortunately, the distribution cost associated with distributing commercially produced DVDs is quite high, which tends to reduce both the number of DVDs that could otherwise be sold and the studio's profit. Further, in order to access the commercially produced DVD, viewers must either travel to a retail establishment and either purchase or rent the DVD. Clearly, many viewers would rather avoid this inconvenience.

Some viewers would rather record a movie from a broadcast rather than purchase or rent the movie on a DVD. However, recording a movie from cable or over the air results in an inferior DVD because the many desirable features of the commercially produced DVD will not be included. For example, a recorded broadcast is limited to a single video stream and a single audio stream. In contrast, commercially produced DVDs provide multiple camera angles and multiple audio channels that the viewer can display by merely pressing a button on their remote control. Accordingly, it would be desirable to provide a home recorded DVD that is the equivalent to a commercially produced DVD even thought it was obtained from a broadcast of the movie. It would be further desirable to provide the movie studios and the broadcaster with an additional stream of revenue when a movie is broadcast whether by a cable or over the air by selling metadata to viewers who would prefer to record a broadcast movie rather than renting or purchasing a commercially produced DVD.

Another problem with a recorded broadcast movie DVD movie arises when it is played on a stand-alone DVD recorder there is limited ability to integrate metadata with the movie. For example, the recorder may randomly or arbitrarily insert chapter markings or the viewer may be able to define desired marks. If, however, the viewer is willing to watch the movie on a Windows-based computer rather than a television, a software program, known as the Microsoft media player, can obtain a limited set of metadata by contacting a Web server to obtain limited track titles and chapter information, DVD cover art and credits. This metadata enables a viewer, using the media player, to navigate through the DVD with more information than simple track numbers but the menu is plain, chapters are crudely set with stop and pause markings that require viewer attention and intervention and the metadata does not include more enhanced features such as multiple camera angles, additional audio tracks or sub-picture streams. Clearly, what is needed is a system and method for acquiring metadata to provide the full theatrical features of a commercially produced DVD when the movie is recorded from an over the air broadcast or cable presentation.

### SUMMARY OF EMBODIMENTS OF THE INVENTION

In accordance with an embodiment of the present invention, metadata is provided to enhance a recorded broadcast movie. With the metadata, the viewer may access the full set of theatrical features normally available only to viewers of a commercially produced DVD. The metadata provides additional menus, titles, background art and supplementary material. Titles and chapter marks are provided with greater granularity and additional video and audio segments are synchronized with the broadcast movie so that the viewer has the option of watching the broadcast movie or watching an enhanced version. The metadata is synchronized with a primitive video feed of the movie using a hashing algorithm.

In one embodiment, metadata is made available on a separate broadcast channel with a separate identifier (PID). The separate broadcast occurs, in one embodiment, substantially simultaneously with the broadcast of the movie. The metadata is acquired as a pay-per-view event when the movie is distributed by a cable or satellite system or as an on-line purchase when acquired over the Internet. In another embodiment, the broadcast movie is recorded to a storage medium and subsequently combined with metadata. Once metadata is acquired, both the movie and the metadata are written to a DVD by the authoring software.

In accordance with one embodiment of the present invention, a DVD recorder is provided as part of a computer system or cable set top box. The DVD recorder includes a video encoder for writing to a DVD disk and a decoder for reading from a DVD disk. The DVD recorder includes a hard disk drive that caches both the broadcast movie and metadata prior to recording to the DVD disk. Authoring software, associated with the DVD recorder, processes the recorded movie by encoding it to a format suitable for DVD, typically MPEG. The encoded movie is analyzed by the authoring software to find the start of the movie and synchronized with the metadata. The metadata preferably includes a sync signal. The authorizing software uses, in one preferred embodiment, a hash algorithm to detect a recognized scene change that is then related to the metadata's sync signal. When the movie is subsequently viewed, the viewer may access the features provided by the metadata.

The authoring software includes a payment module so that the viewer may pay for receiving the metadata. In this manner, a movie studio can earn a return on their investment in a movie from multiple revenue streams, for example, from theatrical release to the theaters, from commercially produced DVD sales and rentals, from distribution agreements with broadcasters and, with the present invention, from the sale of metadata and video games in conjunction with the broadcast of the movie.

In embodiments of the invention as taught in enabling detail below, it is possible to enhance a broadcast program with independently delivered metadata. The metadata is combined with the broadcast movie. The combination is then recorded to a DVD disk to provide functions and featured not otherwise available with a DVD recorded from a broadcast movie. These and other features as well as advantages that categorize the present invention will be apparent from a reading of the following detailed description and review of the associated drawings.

### BRIEF DESCRIPTION OF THE DRAWINGS

FIG. 1 a simplified block diagram illustrating one exemplary embodiment of a broadcast system capable of broadcasting a program and delivering metadata content in accordance with the present invention.

FIG. 2 is a block diagram of a recorder in accordance with the present invention.

FIG. 3 illustrates the process of linking metadata with a broadcast movie in accordance with an embodiment of the present invention.

FIG. 4 illustrates the process of synchronizing metadata with a broadcast movie in accordance with an embodiment of the present invention.

FIG. 5 is a flow diagram in accordance with an embodiment of the present invention showing the acquisition of a broadcast movie with metadata.

### DETAILED DESCRIPTION OF EMBODIMENTS OF THE INVENTION

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

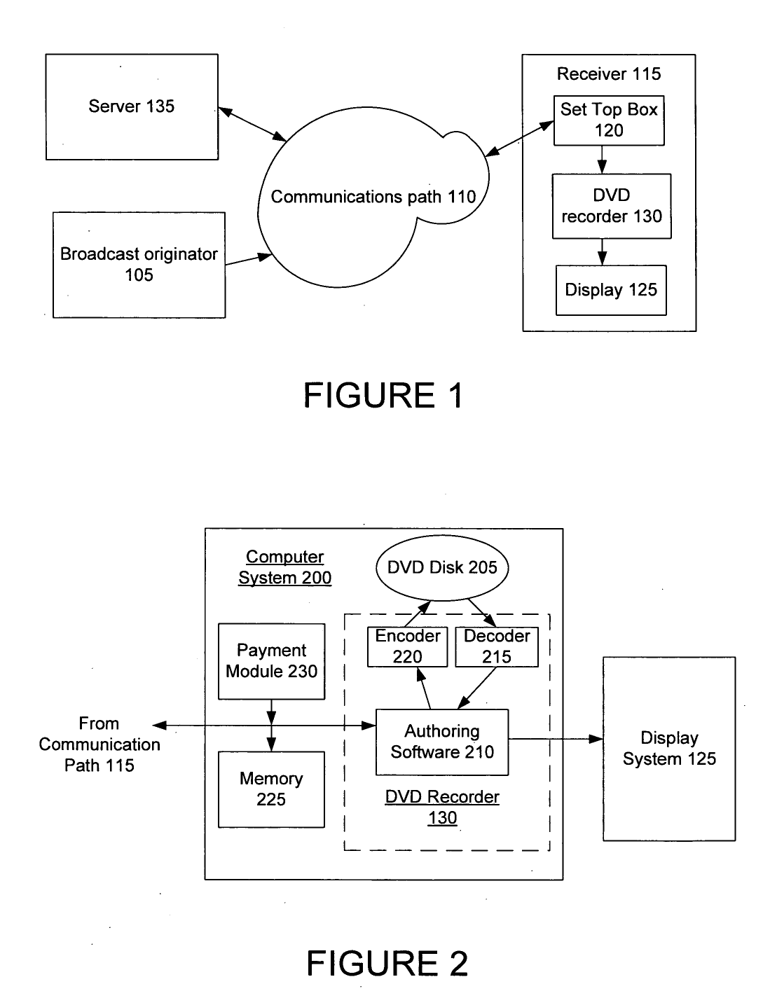

Referring now to the drawings more particularly by reference numbers, a broadcast system 100 is illustrated in FIG. 1 as having a broadcast originator 105 that broadcasts a program over a communication path 110 to at least one receiver 115. Originator 105 may be by a direct broadcast satellite (“DBS”) provider, a multichannel multipoint distribution (wireless cable) provider (“MMDS”), a cable provider or a television broadcast station (“TVBS”). In general, an originator is any television, radio, cable television or other entity that disseminates programs to at least one receiver or viewer. Typical examples of an originator include television and radio broadcasters, such as over-the-air broadcasting companies known as ABC, CBS or NBC, low power UHF broadcasters, cable companies such as Charter Communications or Cox Communications or satellite companies such as EchoStar or News Corp. (DirecTV). Further, originator 105 may include AM/FM radio broadcasters, amateur (“HAM”) radio broadcasts, Citizens Band (“CB”) radio broadcasts and Digital Audio Radio Services (“DARS”) broadcasts.

Communication path 110, by way of example may be over the air, such as when a television or radio broadcaster broadcasts their programming signal from an antenna. Communication path 110 also encompasses cable television networks, satellite broadcasts or any other wire, electrical cable or wireless communication medium, such as the Internet or cellular telephone networks so long as it is capable of transmitting the electrical signals, whether analog or digital, from the originator to one or more receivers 115. [181 Each receiver 115 may include a set-top box 120 to interface a display device 125 to a cable network. Set-top boxes 120 are well known in the art. Further, a recorder 130 is also coupled to the communication path 110 so that, upon receipt of a movie (broadcast by an originator), the movie is recorded to a hard disk drive. Recorder 130 is preferably a video recorder, often referred to as a DVR, that stores audio and video digitally to a hard disk. As is well known in the art, recorder 130 may record a movie while a different program is playing on the display.

Display device 125 may be a television or a computer display. In one preferred embodiment, display device 125 is a high definition digital television capable of receiving digital signals directly from the cable network.

Often, broadcast movies are recorded for subsequent or repeated viewing using a DVD recorder 130. As used herein, viewing includes both the perception of the audio and video information conveyed by the movie. Unlike commercially produced DVD disks, the home recording of a broadcast movie will lack desirable features that are commonly included on the commercially produced DVD. The recorded movie may have limited metadata such as a basic menu, coarsely spaced chapter marks and perhaps simplified graphical overlays automatically generated or obtained from a web site. To overcome the limitations of home recording, the present invention selectively acquires an enriched set of metadata to enhance the viewing experience. The metadata includes various media features such as sub-picture streams, additional camera angles to provide different views, additional video, additional audio tracks and video games related to the movie. An enhanced menu is provided along with background art, interviews of the director and actors. The metadata is transmitted with a separate program identifier (PID) or acquired from server 135 via an Internet connection. The broadcast movie is stripped of transport headers, compressed using the MPEG algorithm, combined with the metadata and saved to a DVD by the authoring software. During playback, the viewer may, by way of example, select an alternate camera angle, a different sound track or access any of the other features from a menu or menus under the control of recorder 130.

FIG. 2 illustrates one embodiment of a DVD recorder 130 in accordance with the present invention. Specifically, recorder 130 is part of a computer system 200 (or a set top box 120) that includes a DVD disk drive 205 for reading and writing DVD disks. Disk drive 205 is accessed by authoring software 210 that reads data recorded on a disk or writes data to the disk in conjunction with a decoder 215 and an encoder 220, respectively. Although not illustrated, recorder 130 may include a plurality of encoders and decoders to handle the transfer of multiple streams simultaneously. In one preferred embodiment, recorder 130 includes computer software and video capture components, commercially known as the Giga Pocket® video recorder, manufactured by Sony Corporation, the assignee of the present invention and the owner of the registered trademark “GigaPocket”. In this embodiment, recorder 130 the software that executes under control of the computer system to control video connections for an external receiver or a direct connection to a cable broadcast system. Thus, recorder 130 may play, record and edit sound, image and data signals from a cable or over the air broadcast as well as manage collections of sound image and data.

Computer system 200, in one embodiment, is a Vaio® computer also manufactured by Sony Corporation who is the owner of the registered trademark “Vaio”. Computer system 200 is a commercially available computer system that includes an processor, RAM and an hard drive capable of storing a full length movie. DVD drive 205 can read and write DVD disks and operates under the control of recorder 130. Computer system 200 interfaces with communication path 115 with either an integrated V.92/V.90 modem or a 10BASE-T/100BASE-TX Ethernet with RJ-45 interface. Available RCA and S-video connections may be connected to an external receiver or directly connected to a cable broadcast system. The preferred operating system is Microsoft's Windows XP operating system.

In operation, computer system 200 receives a broadcast movie via communication path 115 and temporarily retains the movie in memory 225. Memory 225 may include RAM or it may be a hard disk (magnetic storage) or similar temporary storage. A payment module 230 performs the transfer of payment to access the metadata. After payment is received, the metadata is transmitted via communication path and saved in memory 255. Authoring software links the metadata elements to the appropriate portions of the broadcast movie, creates the DVD structure (domains, titles and program chains) before transferring the movie and metadata to the DVD disk in UDF format. UDF refers to the Universal Disk Format which is an optical media file system designed for data interchange and portability so that various operating systems are able to read, write and modify data stored on optical media.

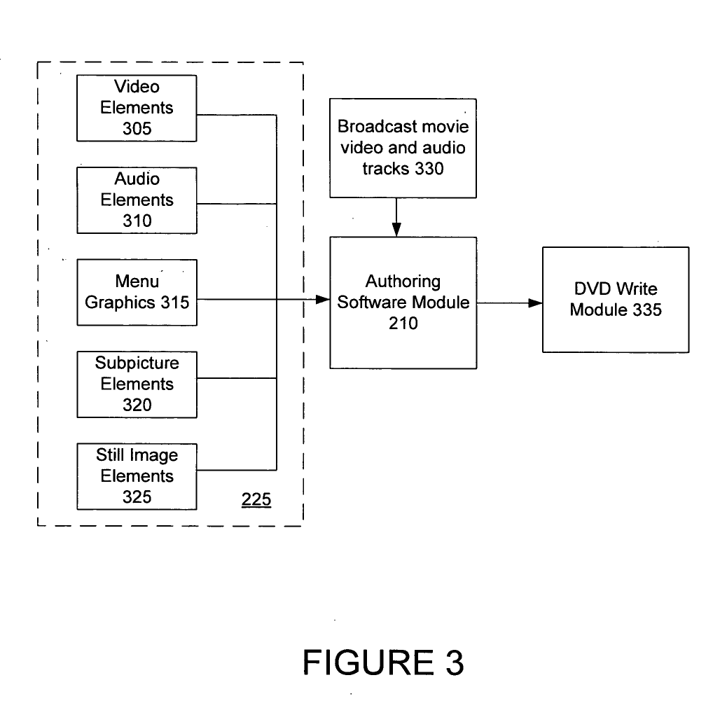

Referring to FIG. 3, metadata is stored in memory 225 and accessed by authoring software 210. As illustrated, the metadata includes video elements 305, audio elements 310, menu graphics 315, subpictures 320 and still image elements 325. Included with the video elements is a set of hash signatures, which are used to identify scene changes. More specifically, authoring software 210 performs media association between the metadata and the raw video and audio data 330 of the broadcast movie, builds video and audio tracks and converts to the UDF format. It then creates title sets, program chains, multiple audio tracks, multiple camera angles, and multiple subpicture streams. Authoring software 210 then organizes domains and sets up the links between program chains or menus. When authoring software 210 has generated the menus, title and program sequences, a first play domain, a video manager domain, menu domains and a plurality of title domains are written to a DVD by write module 335. If the metadata includes video games or other computer code, it is written to the DVD as well.

Authoring software 210 comprises computer-programming instructions that strips transport header information from the broadcast feed to obtain raw video frames of the movie. It then compresses the video using the MPEG algorithm. When compressed, each scene change is represented by at least one GOP, which is a group of pictures having an I-frame followed by a plurality of B-frames and P-frames. Typically, a GOP, which is sometimes referred to as a video object, comprises about 15 frames of video with the initial or I-frame denoting a synchronization point. Authoring software 210 generates a hash signature on each GOP until it locates a known GOP. A known GOP is one that has a hash signature that matches one of the signatures received with the metadata. Once a known GOP is detected, the subsequent frames are counted to determine link points for the metadata elements. In an alternative embodiment, the metadata includes a plurality of known GOPs. Each time the signature of a known GOP is detected, the authoring software generates a link to the related metadata. In this manner, there is no need to count frames, which is especially important if the broadcast movie has been extensively edited for content prior to being broadcast.

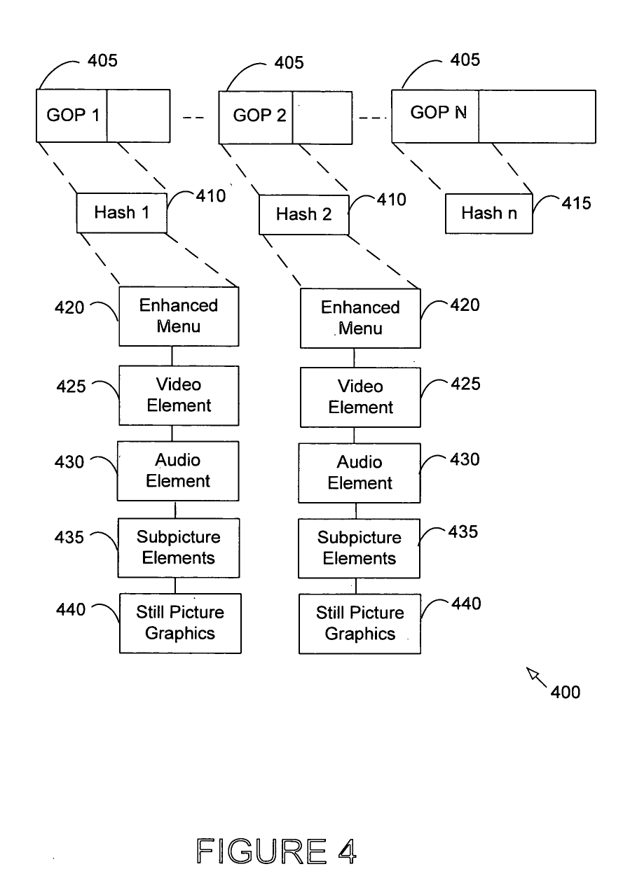

FIG. 4 illustrates a portion of raw movie video at 400. The video comprises a plurality of scenes 405, each of which is identified by at least one GOP having an I-frame followed by the remaining frames in the scene. Authoring software 210 generates hash signature 410 when whenever the start of a GOP is found. If the generated hash signature matches one of the received signatures, authoring software 210 operates to synchronize video and audio clips with the metadata and to insert chapter points at each scene change. If the generated hash signature does not match, such as if the recorder started recording prior to the start of the movie, the scene may be discarded. Once the initial GOP is recognized, the start of subsequent scenes may be found by counting frames instead of hashing each GOP. In other instances, the recording may have started after the movie broadcast started. In this instance, the recording may start at some point other than a scene change. Thus, it may be necessary to hash several GOPs until a valid has signature is found. Further, it may be desirable to identify each scene change and edit out commercials or other intervening video or audio material. The authoring software recognizes the hash signatures and uses instructions in the metadata to delete the commercial or added scene. For example, these instructions may specify that starting at a specific hash signature, delete all GOPs until a second specific hash signature is located. Alternatively, if the authoring software finds a matching signature, additional video may be inserted. For example, to reinsert scenes deleted for broadcast, the metadata can specify that when hash signature X is located, the insert selected video and audio segments. In FIG. 4, the hash signature for GOP N is not recognized and, accordingly, there is no corresponding metadata. As illustrated in FIG. 4, a hash signature identifies each scene change. However, it is to be understood that once the first known hash signature is found, subsequent scene changes may be found by frame counting.

When a scene change is identified, the corresponding metadata for that scene is linked thereto as a program chain within a title domain. For example, each enhanced menu 420 identifies hash signature that correlates to the start of play of a specific audio and video element. From menu 420, the viewer may access a different camera angle selected from among available video elements 425 or a different audio track selected from available audio elements 430 selected using the recorder's remote control device. The video and audio elements may include a different clip of the movie, comments regarding the scene by the director or the actors or may comprise a video game related to the movie. In other instances, the viewer may select subpicture elements 435 or still picture graphics 440.

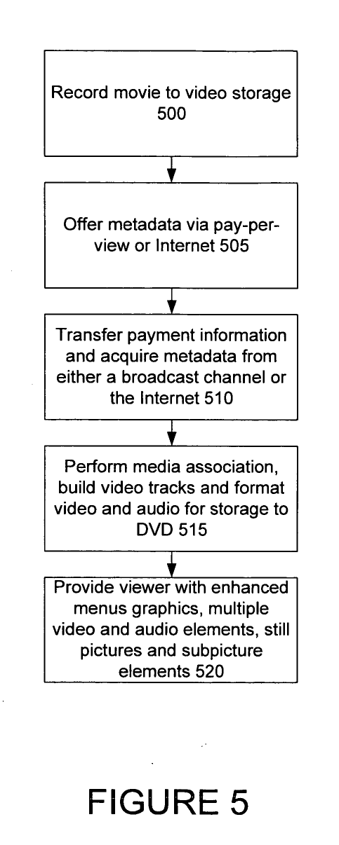

FIG. 5 illustrates the operational sequence of authoring software 210. In step 500, a recorded movie stored in video memory. The authoring software strips out transport headers to obtain raw video and audio. Authoring software then compresses the video and audio using the MPEG algorithm and identifies each scene.

In step 505, the viewer is offered the opportunity to acquire metadata. The metadata may be broadcast over a separate channel such as a pay-per-view cable channel. When the movie is broadcast over the air, the metadata may be acquired from a Web server.

If metadata is requested, a payment transaction is initiated as indicated at step 510. This transaction may be automated as part of a paid subscription service or as a single payment. If the paid subscription option is invoked, payment for the metadata is automatically and the metadata is transferred to the video store. If the payment is a one-time transaction, the user who enters credit card and personal (billing address, Internet Protocol (IP) address etc.) information at a Web-based shopping cart. Once payment is received, the metadata is transferred to memory 225.

Authoring software then performs the media association, builds tracks and formats the video, audio and metadata for storage on the DVD as indicated at step 515. The authoring software links metadata for each scene within one or more title domains so that when the DVD movie is accessed for viewing, the viewer is presented an enhanced menu and improved chapter mark granularity so the viewer can skip to the desired location and watch either the recorded movie or an alternative video or audio stream. In this manner the viewer may easily view a different camera angle, change audio or access other related features not otherwise provided by the recorded broadcast movie. The viewer navigates through the menus using standard DVD control commands, which are entered using the standard remote control device or via the keyboard if the recorder is part of a computer system as indicated at step 520.

With the authoring software's payment module, the viewer may pay for receiving the metadata as a condition precedent. Thus, a movie studio can generate incremental income from the sale of metadata, which is distributed either by a cable company, broadcaster or via the Internet. Both the broadcaster and the studio can increase the return on their investment in the movie. The viewer is provided with an enhanced viewing experience without the inconvenience of having to deal with renting or buying a DVD from a third party. In addition to metadata, the studio can also distribute video games related to the movie or targeted to a particular demographic group. In one embodiment, the video games are distributed together with the metadata. In an alternative embodiment, distribution of the video game is contingent upon payment of an additional fee. In addition to video games, other entertainment or educational movies or other forms of entertainment can be transferred to the DVD for use or viewing by the viewer.

Although the invention has been described with respect to specific embodiments thereof, these embodiments are merely illustrative, and not restrictive of the invention. For example, the recorder may be a set-top box rather than a computer system. The communication path may be a cable system capable of broadcasting a movie while simultaneously providing an Internet connection for downloading of the metadata. In other embodiments, metadata may be broadcast on a separate channel rather than accessed via the Internet while additional metadata features are provided via the Internet. Further, software algorithms may implement the functions provided by system hardware components and program routines may be implemented in hardware. Further still, the metadata may be encrypted and otherwise encoded so that it cannot be readily copied to other DVD disks. Clearly, the metadata may include copyright notice and other programs that function to minimize the use of counterfeit DVD disks.

The method described herein may be implemented in any suitable programming language can be used to implement the routines of the present invention including C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

As used herein “memory” for purposes of embodiments of the present invention may be any medium that can contain, store, communicate, propagate, or transport the program for use by or in connection with the instruction execution system, apparatus, system or device. The memory can be, by way of example only but not by limitation, an electronic, magnetic, optical, electromagnetic, infrared, or semiconductor system, apparatus, system, device, propagation medium, or computer memory.

Reference throughout this specification to “one embodiment,” “an embodiment,” or “a specific embodiment” means that a particular feature, structure, or characteristic described in connection with the embodiment is included in at least one embodiment of the present invention and not necessarily in all embodiments. Thus, respective appearances of the phrases “in one embodiment,” “in an embodiment,” or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of the present invention can be achieved by any means as is known in the art. Distributed, or networked systems, components and circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A method for enhancing broadcast movies comprising the steps of:
Acquiring a selected broadcast movie;
Acquiring said metadata;
Associating said metadata with said movie; and
Providing a portion of said metadata for viewing on a display in response to a viewer command whereby said portion of metadata is associated with a selected scene of said movie.

2. The method of claim 1 wherein said metadata is downloaded from a Web server.

3. The method of claim 1 wherein said metadata is received from a pay-per-view cable channel.

4. The method of claim 1 wherein authoring software identifies at least one GOP that identifies the start of a known scene.

5. The method of claim 4 wherein a hash signature is calculated for said at least one GOP and compared to known signatures provided with said metadata.

6. The method claim 1 further comprising the step of acquiring payment prior to transferring said metadata.

7. The method claim 1 further comprising the step of performing media association, building tracks and formatting said movie and said metadata for storing on a DVD disk.

8. A system to implement the method of claim 7.

9. A computer to implement the method of claim 7.

10. A computer-readable medium having instructions for assisting in the implementation of the method of claim 7.

11. A method for viewing a broadcast movie comprising the steps of:
Recording said broadcast movie;
Acquiring metadata relating to said movie;
Identifying at least one scene of said movie;
Based on said identification associating metadata with said scene; and
Providing a viewer of said DVD disk with control command for selecting either the broadcast movie or one or more video elements, audio elements, subpicture elements or still picture graphics provided by said metadata.

12. The method of claim 11 wherein said acquiring step further comprises the steps of collecting payment for acquiring said metadata.

13. The method of claim 12 wherein said associating step includes the steps of:
Defining a title domain having a plurality of program chains;
Generating a plurality of chapter marks at each scene change
Identifying video elements, audio elements, subpicture elements and still picture graphics associated with at least a portion of said chapter marks; and
Selecting supplementary material from a menu in response to a viewer command, said supplementary material derived from said video elements, audio elements, subpicture elements and still picture graphics.

14. A method for enhancing viewing of a movie recorded to a DVD disk using MPEG compression comprising the steps of acquiring metadata associated with said movie and, during the display of said movie, providing the viewer the option to access metadata related to the displayed portion of said movie by calculating a signature for at least one frame of said movie, said signature uniquely identifying a portion of said related metadata.

15. The method of claim 14 further comprising the step of concluding a purchase transaction prior to accessing said metadata.

16. The method of claim 15 further comprising the steps of:
Recording said metadata to said DVD disk;
Subsequently, viewing said DVD disk and providing a viewer the option to access supplementary material in addition to said movie by:
Identifying a known scene of said movie;
Inserting a plurality of chapter marks at a plurality of scenes following said known scene; and
Accessing features related to a selected one of said scenes, said features provided by said metadata and linked to said selected scene.

17. The method of claim 16 wherein a hash signature identifies said known scene.

18. A system to implement the method of claim 17.

19. A computer to implement the method of claim 17.

20. A computer-readable medium having instructions for assisting in the implementation of the method of claim 17.

21. A DVD recording system for enhancing viewing of a movie recorded to a DVD disk comprising:
A receiver for receiving a broadcast movie;
A recorder for transferring said broadcast movie to a DVD disk; and
Authoring software module for acquiring metadata associated with said movie and providing the viewer the option to access supplementary material provided with said metadata during display of said movie; said authoring software including a hash engine for identifying the start of at least one scene of said movie and means for combining said metadata with said broadcast movie.

22. The DVD recording system of claim 21 further comprising a software module for concluding a purchase transaction prior to accessing said metadata.

23. The DVD recording system of claim 22 further comprising means for receiving and recording said metadata to said DVD disk.

24. The DVD recording system of claim 23 further comprising means for determining a known location in the recorded movie and for linking said metadata thereto.

25. The method of claim 24 wherein said determining means comprises a hash signature generator.

26. A method for generating revenue from when broadcasting movies comprising the steps of:
Broadcasting and recording a movie;
Offering metadata related to said movie, said offer being accepted by payment of an agreed upon fee;
Linking said metadata with said movie; and
Authoring a DVD having at least a plurality of video and audio streams for viewer selection from a plurality of menus derived from said metadata, said menus providing viewer options in response to display of said movie.

27. The method of claim 26 wherein said acceptance comprises a per-per-view payment added to a viewer's monthly bill.

28. The method of claim 27 wherein said metadata has a program identifier and is broadcast on a separate channel from said movie.

29. The method of claim 28 wherein said acceptance comprises an Internet payment at a Web site having metadata available for download.

30. The method of claim 29 wherein said metadata is downloaded to a DVD recorder in response to a viewer's payment.
